(19) United States
(12) Patent Application Publication
(10) Pub. No.: US 2010/0169016 A1
(43) Pub. Date: Jul. 1, 2010

(54) SAFE SIDE-VIEW SYSTEM FOR THE DRIVER WHEN OVER-TAKING THE VEHICLE IN THE FRONT ON A SINGLE LANE SHARED ROAD

(76) Inventor: Lakshmi Aroop Kodali, San Jose, CA (US)

Correspondence Address: Lakshmi Aroop Kodali, 1448 Cedarmeadow ct, San Jose, CA, 95131, US

(21) Appl. No.: 12/345,279

(22) Filed: Dec. 29, 2008

(51) Int. Cl. G08G 1/16

(52) U.S. Cl. 701/301

(57) ABSTRACT

A safe viewing system for the drivers when over-taking the vehicle in the front with out going too much into the way on the road serving the traffic in the opposite direction, especially useful on a shared road serving to and fro traffic in single lane. Here, I assume that it is a left-hand driving system while this technology can be applied to the right-hand driving system also. If there is a large vehicle in the front and the driver behind wished to overtake that vehicle, the driver has to steer the vehicle towards the right to see the traffic coming from the opposite direction. If the vehicle in the opposite direction is in very close proximity, there would be a potential for a head-on collision as the driver has to back into his lane. Through this system, the driver needs to steer a tiny bit to see oncoming traffic.

### REFERENCES CITED

### U.S. Patent Documents

U.S. Pat. No. 6,871,971 B2 (Morrison) Back-Up Mirror System for Vehicle Safety When Backing Into Lane(s) Of Cross-Traffic with Back-Up Mirror Method

### BACKGROUND OF THE INVENTION

The present invention falls into the category of automobile safety improvement for aiding drivers while overtaking vehicles in a single lane road serving both incoming and outgoing traffic.

When a driver of a vehicle wants to overtake the vehicle in the front, he has to steer his vehicle to the right to see the oncoming traffic. This might be very dangerous many times if there is a vehicle in the opposite direction in a very close proximity. This would leave the driver with no time to steer back into his lane behind the vehicle he wanted to overtake, thus causing a fatal head on collision. This will also cause a lot of inconvenience to the remaining traffic on the road.

Here is where my invention would bridge the gap of the side eye which is not possessed by the human being.

Especially, in situations where the vehicle in the front is monstrous in size like a truck in which case the driver absolutely cannot see the oncoming traffic, this invention will have significant advantages in safely overtaking the truck.

### BRIEF SUMMARY OF THE INVENTION

In accordance with the present invention a side eye system comprised of two mirrors which are positioned parallel at an angle of 45° with a line between them similar to the periscope. The light hits the mirror which is close to the side mirror at a 45-degree angle and reflects away at the same angle, which bounces it to the adjacent mirror. Thus the reflected light hits the second mirror at a 45-degree angle and reflects away at the same angle, to the LCD screen on the dash board.

Thus the system provides the driver with a alternative view for viewing the oncoming traffic still while going behind the vehicles.

While the primary advantage is explained above, several other advantages are as follows:
(a) Driver does not have to move from his seat to access the utility.
(b) Driver can access the information from the screen conveniently location on the vehicles dashboard.
(c) Easily installed even in existing vehicles.
(d) No obstruction to other existing views that are already in place for the driver.
(e) Inexpensive and less complex system.
(f) Simple in construction with relatively fewer parts for accomplishing the intended purposes.

### BRIEF DESCRIPTION OF THE SEVERAL VIEWS OF THE DRAWINGS

The present invention will be better understood with the following detailed description and drawings.

FIG. 1 explains the problem wherein the driver of vehicle 2 begins to steer his vehicle into the other line serving the opposing traffic and see a vehicle coming through (Vehicle #3). The travelling direction is showed through 11. Most times, the drivers of both the vehicles do not have much time to steer back into their lane or control their vehicle speed to avoid collision.

FIG. 2 illustrates the basic idea behind this present invention where in the eye (4) on the side mirror would capture the live image of the traffic from the opposite direction and thus having it available on the LCD screen on the dashboard of the car. The travelling direction is showed through 12. This invention would eliminate the driver to steer his vehicle into the other line which can potentially result in an accident.

FIG. 3 is a detailed view of where the eye is on the side mirrors of the car. 5 and 6 are the eyes (opening on the back side of the side view mirror).

FIG. 4 shows the detailed mechanism of the periscope which acts as the principle behind this invention. 7 and 8 are the mirrors set parallel at 45-degree angle. 9 is the source of light (object) and 10 is where the output can be viewed which in this case is via LCD screen

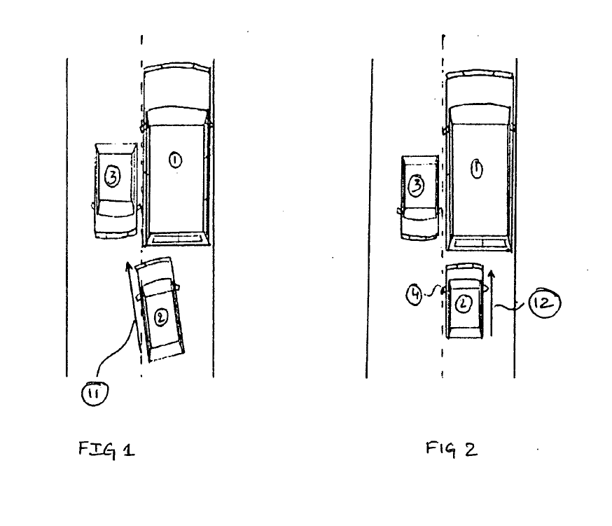

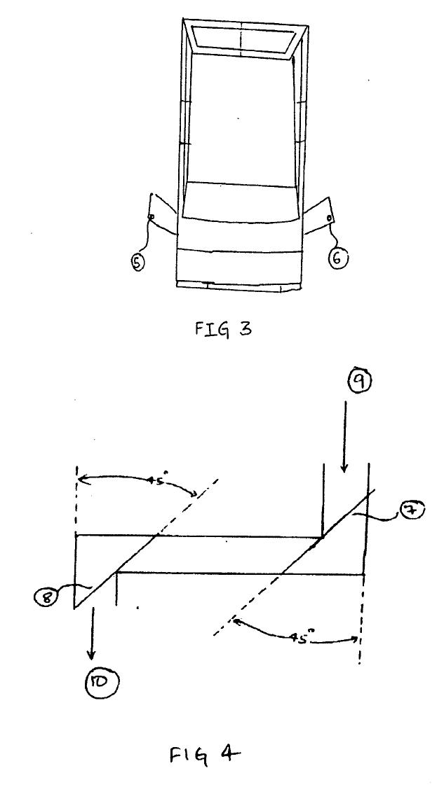

### DETAILED DESCRIPTION OF THE INVENTION

Operation of the Invention: The mechanism of the usage is very apparent from the figures detailed out.

The present invention manly consists of the following elements: an opening on the back side of the side view mirror, two mirrors set at 45-degree angle, a LCD screen to serve as an output to the image procured.

On the road, when the driver prefers to overtake the vehicle in the front, this invention will aid the driver in stress free and accident free driving. As described in the earlier sections, the opening in the back side of the side view mirror which is called the eye will capture the image of the opposing traffic on the other lane. This light hits the mirror which is close to the opening (eye) at a 45-degree angle and reflects away at the same angle, which bounces it to the adjacent mirror. Thus the reflected light hits the second mirror at a 45-degree angle and reflects away at the same angle, to the LCD screen on the dash board.

The scope of the present invention should not be limited by the embodiments and ramification herein described, but encompasses any and all embodiments within the true spirit and scope of the following claims and their legal equivalents and such equivalent constructions which do not depart from the scope of the following claims.

What is claimed and desired to be secured by the Letters of Patent of US is:

1. A side-eye to the vehicle for improving safety when a driver begins to overtake the vehicle in the front by viewing the traffic coming in the opposite direction, comprising:
1) a vehicle of any sort—including a driver's side, and a passenger side, doors of both driver side and passenger side, front bumper, engine parts under bonnet. This is applicable for both sides of the vehicle (driver side and the passenger side).
2) the side eye installed on the side view mirrors on both the sides along with the LCD screen mounted on the dashboard of the vehicle.
3) this said side view system can be applied to both sides of the car and both sides of driving systems.
